(19) United States
(12) Patent Application Publication
(10) Pub. No.: US 2001/0032171 A1
(43) Pub. Date: Oct. 18, 2001

(54) System and method for trading commodities

(76) Inventors: Jerry ten Brink, Boston, MA (US); Joshua ten Brink, Boston, MA (US)

Correspondence Address: R. Bennett Ford, ROY, KIESEL & TUCKER, P.O. Box 15928, 2355 Drusilla Lane, Baton Rouge, LA, 70895-5928, US

(21) Appl. No.: 09/800,285

(22) Filed: Mar. 6, 2001

Related U.S. Application Data
(60) Provisional application No. 60/187,622, filed on Mar. 7, 2000.

(51) Int. Cl. G06F 17/60

(52) U.S. Cl. 705/37

(57) ABSTRACT

A system for trading commodities. The system includes a selling station, one of more buying station, and a server. Sellers may generate offer data at the selling station and post it on the system. Prospective buyers may generate counter-offer data and post it on the system in response to the offer data. The seller and buyers may communicate directly via e-mail. Once the buyer and seller have agreed upon terms, the buyer will post a counter-offer reflecting these terms and seller will accept. Once the seller has accepted one or more counter-offers, the system will notify prospective buyers and generate a purchase order and transmit the same to the seller and all successful buyers. During negotiations, the identity of the seller will be known to all buyers and the identity of all buyers will be known to the seller; however, the buyers will not know the identities of the other buyers although they will know the terms of any counter-offers made by other prospective buyers. The system may be operated where the buyer initiates the transaction. In this case, the seller will make the counter-offer and the buyer will have the right to accept or reject counter-offers. Additionally, the identity of the sellers will be kept from the other sellers.

### BENEFIT OF PROVISIONAL APPLICATION

This application claims benefit of provisional application No. 60\187,622 which was filed on Mar. 7, 2000, and is hereby incorporated by reference in its entirety.

### BACKGROUND OF THE INVENTION

1. Field of the Invention

The invention relates to computer based trading platforms in general and trading platforms for commodities in particular.

2. Prior Art

In the prior art, many commodities and particularly seafood, are sold via face-to-face or telephonic negotiations. This results in inefficiencies in the market, which arise principally from the lack of numerous potential buyers being able to bid for the same goods at the same time. Instead, potential buyers must call around in an attempt to find sellers capable of meeting the order. The price paid by the buyer, while not totally divorced from market forces, depends largely upon what price the buyer and seller negotiate for that particular transaction.

Bargaining under such isolated conditions distinguishes traders in commodities such as seafood from traders in markets where there is an open exchange such as is the case with cotton or soybeans. In exchange based markets, large numbers of buyers and sellers are present in one place and are able to efficiently determine the market price for a commodity. In smaller scale more isolated negotiations, lack of information on the part of the buyer or seller can easily result in a seller getting less for his product than another buyer is willing to pay.

Such inefficiencies arise, at least in part, because of the “bird in the hand” phenomenon. If a seller gets an offer for that day's fresh shrimp that he believes is too low, he must negotiate with the buyer by asking him to raise his price. If the buyer refuses, the seller must either refuse the offer or at least put the prospective buyer off while he attempts to find another buyer willing to pay more for the shrimp. As the seller searches for another buyer, he runs the risk that the original buyer will find another seller and that he will be left holding the shrimp. The fact that fresh seafood generally commands a significantly higher price than frozen seafood adds an additional incentive to accept offers when they are made. Unlike traders of other commodities, traders of perishable commodities cannot simply hold their product until another buyer is found. Rather, perishable commodities must be moved while they are fresh. Thus, the risk in declining offers is greater for dealers of perishable commodities than for other commodity merchants.

Many of these disadvantages could be eliminated if the commodity dealer were able to simultaneously speak to several potential purchasers at once. Therefore, a commodity trading system meeting the following objectives is desired.

### OBJECTS OF THE INVENTION

It is an object of the invention to provide a commodity trading system where sellers can simultaneously communicate with numerous buyers.

It is another object of the invention to provide a commodity trading system that allows sellers to negotiate in confidence with individual buyers.

It is still another object of the invention to provide a commodity trading system that allows sellers and buyers to know the identity of their negotiating partner during negotiations.

It is yet another object of the invention to provide a commodity trading system that prevents buyers from knowing the identity of other buyers whom they are bidding against.

It is another object of the invention to provide a commodity trading system allows buyers and sellers to complete trades over the Internet.

### SUMMARY OF THE INVENTION

The invention comprises a commodity trading system which includes a server, a plurality of remote buying stations and at least one selling station. Each selling station is configured to generate offer data as specified by the seller and to transmit this data to the server. The server is configured to transmit the offer data to the plurality of remote buying stations. The remote buying stations should each be configured to transmit counter-offer data as specified by the buyer and to transmit this data to the server. The server should preferably be configured to transmit this counteroffer data to the other remote buying stations and to the seller. In a preferred embodiment, the server should withhold the identity of the buyer from the other buyers, but not from the seller. The data in the counter-offer set will be substantially the same as data in the offer set qualitatively, differing primarily in value, i.e. differing in whether to pay $X or $Y per pound.

Thus, the seller should be able to review several counter-offers at once to determine what the market price for his product is. The selling station is configured so that the seller may direct electronic communications to the server which is in turn configured to direct the electronic communications to one or more buying stations as directed by instructions provided to the server by the selling station. Thus, the seller may negotiate privately with any prospective buyer.

The system should be further provided with an archive station and a clearing station. In the preferred embodiment when the party initiating the transaction, the seller in the foregoing example, accepts one or more of the counter-offers, the selling station will direct an acceptance message of the counter-offer(s) to the server which in turn will direct the acceptance message(s) to all of the buying stations. Upon receipt of the acceptance message, the buying station(s) will direct the counter-offer data which has been accepted to the server. The server should be configured to direct the accepted counter-offer to the archive station and to the clearing station. Preferably, the system is configured to allow the archive station to direct the terms of previous transactions to the server which will then direct it to buyer or seller stations upon the receipt of instructions from either station to do so. The clearing station should generate a purchase order according to the terms of the accepted counter offer, which is then transmitted to the seller and buyer(s). The purchase order will preferably be transmitted to server via electronic mail which will then direct the electronic mail to the seller station and the remote buyer station(s). The clearing station may also be connected to a printer which may generate conventional paper copies of the purchase order(s) which may then be directed to the seller and buyer(s) via conventional media, such as the mails or facsimile.

Each of the different stations should be configured to communicate with the server, preferably via the Internet or with wireless transmissions. However, in another embodiment, the stations may be configured to communicate with the server via a local area network (LAN).

It should be understood that in the foregoing example the seller initiated the transaction. However, the invention is designed to allow the buyer to initiate the transaction as well. Everything works in generally the same way, except that the buying station will generate the offer data, while there will be a plurality of selling stations that will generate the counter-offer data. The identity of the sellers will be made available to the buyer, but not the other sellers. Finally, the sale will close when the buyer accepts one or more of the seller's counter-offers.

### DETAILED DESCRIPTION OF THE PREFERRED EMBODIMENT

The present invention involves a system for trading commodities, and particularly perishable commodities such as seafood. Users of the system will preferably subscribe to the system at which point they will agree to be bound by the terms of the system. However, the system may be operated on an open access basis, allowing standard contract provisions to govern the users' transactions.

In the preferred embodiment, a seller will be located at a selling station 1. Selling station 1 will preferably include a central processing unit (CPU) 2, a monitor 3 and a keyboard 4 or other means of inputting data into selling station 1. CPU 2 has a clock 5 and an operating system 6 stored in memory. CPU 2 executes instructions stored in Read Only Memory (ROM) 7 for gathering offer data 8. The Random Access Memory (RAM) 9 temporarily stores information passed to it by CPU 2.

Selling station 1 will also preferably have a modem 10 or other means of communicating with other stations, such as a wireless transmitter. When modem 10 is used, it will preferably be connected to telephone lines or fiber optic cables or other media capable of carrying signals to the Internet or to a the lines of an LAN.

A seller will initiate a transaction by entering an account number and password into seller station 1. Seller station 1 will transmit the password to a server 11. Server 11 comprises a CPU 12, a clock 13, and an operating system 14 associated therewith. Server 11 executes the instructions of a program stored in ROM 15. During execution of the instructions, CPU 12 temporarily stores information in RAM 16.

Server 11 will also preferably have a modem 17 or other means of communicating with other stations, such as a wireless transmitter. When modem 17 is used, it will preferably be connected to telephone lines or fiber optic cables or other media capable of carrying signal to the Internet or to a the lines of an LAN.

CPU 12 of server 11 will compare the account number and password of the user to its user database 18 to determine if the user is a registered user. If the numbers match, the user will be given access to the features and services described below.

Once the seller is logged onto the system, he may enter offer data 8 into the selling station 1. Offer data 8 can include any variety of information pertinent to the sale of the commodity in question. CPU 2 of selling station 1 will preferably generate a template to elicit offer data 8 from the seller. Offer data 8 may include the currency (dollars, yen, francs, etc.) which the seller wishes to use; pricing units (lbs., kilos, cases, ounces, etc.); product origin; date that offer will remain open; date that shipment will be required; shipping terms and location; payment terms; type and grade of product desired or offered; quantity of product desired or offered; desired or offered processing (fresh, filet; frozen, etc); unit size (e.g. 26-30 count shrimp, 5 oz lobster tails, etc.); packaging options; proposed price per unit; and any miscellaneous terms not specified above.

The inventors specifically contemplate including in the set of offer data 8, various specific payment options including 50% against bill of lading and 50% upon product receipt or 100% payable by letter of credit. Additional options may be made available or the parties may include their own payment terms.

When the seller is finished, CPU 2 should generate a preview of offer data 8 which should be displayed on monitor 3. Once the user has reviewed offer data 8, he may instruct selling station 1 to transmit offer data 8 to server 11. CPU 12 of server 11 will direct offer data 8 to one or more buying stations 19.

Buying station 19 will generally be substantially identical to selling station 1. Preferably buying station 19 and selling station 1 will be fully interchangeable. Buying station 19 should preferably include a central processing unit (CPU) 20, a monitor 21 and a keyboard 22 or other means of inputting data into buying station 19. CPU 20 has a clock 23 and an operating system 24 stored in memory. CPU 20 executes instructions stored in Read Only Memory (ROM) 25 for receiving offer data 8 and gathering counter-offer data 29. The Random Access Memory (RAM) 27 temporarily stores information passed to it by CPU 20.

Buying station 19 will also preferably have a modem 28 or other means of communicating with other stations, such as a wireless transmitter. When modem 28 is used, it will preferably be connected to telephone lines or fiber optic cables or other media capable of carrying signal to the Internet or to a the lines of an LAN.

Server 11 may direct offer data 8 to buying stations 19 in one of several ways. First, all sets of offer data 8 may be automatically be sent to all buying stations 19 in the system. Second, the system may allow users to identify which types of offers they are interested in, and only send offer data 8 to the buying stations of users who have expressed an interest in that type offer data 8. Third, server 11 may post the offer data 8 on a station that is accessible by all users. Prospective buyers may access the content on this station on buying station 19 via server 11, and download complete offer data 8 for any offer that interests them. If the latter method is used, offers should preferably be organized by subject matter of the offer and time. The invention is not limited to any particular method of notifying potential buyers of an offer provided they are in fact notified.

When buying station 19 receives offer data 8, the prospective buyer may use buyer station 19 to generate counter-offer data 29. Counter-offer data 29 will be the same type of information as offer data 8; however, it will usually differ in quantity. For example, offer data 8 may include a price of $2.50/lb. for shrimp and counter-offer data 29 may include a price of $2.40/lb. However, the prospective buyer may agree to the terms suggested by the prospective seller. In that case, offer data 8 and counter-offer 29 will be identical.

When the seller is finished, CPU 20 should generate a preview of counter-offer data 29 which should be displayed on monitor 21. Once the user has reviewed counter-offer data 29, he may instruct buying station 19 to transmit counter-offer data 29 to server 11. CPU 12 of server 11 will direct counter-offer data 29 to selling stations 1, either directly or indirectly.

Counter-offer data 29 may be transmitted directly to selling station 1. Alternatively, counter-offer data 29 may be posted on server 11 or other station. In this embodiment, server 11 should automatically notify the prospective seller by sending an electronic message to selling station 1 that a counter offer has been posted. The prospective seller may then review the counter-offer to determine whether its terms are acceptable or if further negotiation is necessary.

In the preferred embodiment, other prospective buyers will be apprised of the counter-offer. This may be accomplished by configuring server 11 to transmit counter-offer data 29 directly to other buying stations 19. Alternatively, counter-offer data 29 may simply be posted on server 11 or another station and made available to other system users in the same way that is available to the seller. In either instance, the portion of counter-offer data 29 which includes the identity of the buyers will preferably not be disclosed to the other buyers, although it will be disclosed to the seller. This will help prevent collusion among the prospective buyers, while allowing the prospective buyer and seller to know each other's identity and to take that into consideration when deciding whether and on what terms to do business.

If further negotiation is required after counter-offer data 29 has been posted, the seller can generate a new set of offer data 8 and post it for all potential bidders to review. Alternatively, the seller may choose to negotiate directly with one or more potential sellers. In this case, the seller may use selling station 1 to send an electronic message to server 11 which will then direct it to the appropriate buying stations 19. Communications may continue in this fashion until a deal is struck.

In the preferred embodiment, the party initiating the transaction will retain control over which counter-offers if any to accept. Thus, a counter-offer that agreed to all of the terms of the original offer would not necessarily result in a sale. Rather, the in preferred method, when a prospective buyer posts a counter-offer that is acceptable to the seller, the seller must accept the counter-offer. The seller will generate an accept message on selling station 1 which will direct the acceptance message to server 11, which in turn will direct it to buying station(s) 19 of the buyer(s) whose counter-offer(s) was/were accepted. The terms of the accepted counter-offer will also be made available to the other prospective buyers, either by server 11 directly transmitting it to buying stations 19 or by posting the terms of the accepted offer on server 11 or on another station accessible via server 11.

Server 11 will transmit the accepted counter-offer data 29 to a clearing station 30. Clearing station 30 should preferably include a central processing unit (CPU) 31, a monitor 32 and a keyboard 33 or other means of inputting data into clearing station 30. CPU 31 has a clock 34 and an operating system 35 stored in memory. CPU 31 executes instructions stored in ROM 36 for receiving accepted counter-offer data 29 and converting counter-offer data 29 into purchase order data 37. RAM 38 temporarily stores information passed to it by CPU 20. In one embodiment, clearing station 30 may be incorporated into server 11.

As indicated above, clearing station 30 will convert accepted counter-offer data 29 into purchase order data 37. Purchase order data 37 will be used to generate a purchase order having the same terms as the accepted counter-offer. Clearing station 30 will electronically transmit this purchase order to selling station 1 and to buying station(s) 19 of the successful buyer(s). Clearing station 30 may also be provided with a printer 38 which may be used to print a hard copy of the purchase order as well. This purchase order may sent to the seller and buyers via conventional means such as facsimile or mail.

In the foregoing description, the invention has been described in the situation where the seller has initiated the transaction. It should be understood that the buyer may initiate the transaction as well. In this case, the buyer will post an offer and one or more prospective sellers will post counter-offers. The identity of each prospective seller will preferably be known to the buyer but not to the other prospective sellers. Finally, the buyer, as the initiator, will have the final right to decide whether to accept or reject counter-offers posted by prospective sellers. Other than these differences, the system will operate in substantially the same way regardless of which party initiates the transaction.

The inventors contemplate that when the system is used to trade seafood, sellers such as fishing vessels still at sea may use this system to sell their catch before they reach port, saving valuable time. Purchasers of the commodity may then use the system to sell their product to other downstream buyers, minimizing the need to the inventory the product until a buyer can be found.

The foregoing invention has been described primarily in the context of seafood trading; however, other uses and embodiments of the invention will occur to those skilled in the art, and are intended to be included within the scope and spirit of the following claims.

1. I claim a system for trading commodities comprising
a selling station configured to generate offer data for said commodity and to transmit said offer data to a server, said server configured to transmit said offer data to one or more buying stations, said buying stations configured to generate counter-offer data and to transmit said counteroffer data to said server, said server further configured to transmit said counter-offer data to said selling station, said selling station further configured to generate an acceptance command accepting the terms set forth in any counter-offer data and to transmit said acceptance command to said server, said server configured to transmit the acceptance command and the accepted counter offer data to a clearing station, said clearing station configured to generate a purchase order according to the terms of the accepted counter-offer data, said clearing station further configured to transmit said purchase order to said selling station and said buying station.

2. A system for trading commodities according to claim 1 wherein said selling station and said buying station are configured to communicate electronically with each other via said server.

3. A system for trading commodities according to claim 1 wherein the commodity is seafood.
